(19) United States
(12) Patent Application Publication
(10) Pub. No.: US 2025/0183548 A1
(43) Pub. Date: Jun. 5, 2025

(54) ELECTROMAGNETIC REFLECTION APPARATUS AND BASE STATION

(71) Applicant: Huawei Technologies Co., Ltd., Shenzhen (CN)

(72) Inventors: Yuefeng Hou, Shenzhen (CN); Xinyu Gao, Beijing (CN); Hengheng Wu, Shenzhen (CN)

(21) Appl. No.: 19/042,422

(22) Filed: Jan. 31, 2025

Related U.S. Application Data
(63) Continuation of application No. PCT/CN2023/110166, filed on Jul. 31, 2023.

(30) Foreign Application Priority Data
Aug. 2, 2022 (CN) 202210922401.7

(51) Int. Cl. H01Q 19/10; H01Q 1/24; H01Q 3/32; H01Q 9/04

(52) U.S. Cl. CPC H01Q 19/10; H01Q 1/246; H01Q 3/32; H01Q 9/0414

(57) ABSTRACT

An electromagnetic reflection apparatus and a base station are provided. The electromagnetic reflection apparatus includes a radiation portion and a phase adjustment portion that are disposed in a stacked manner. The radiation portion includes a radiation patch, and the radiation patch is configured to receive and transmit an electromagnetic signal. The phase adjustment structure includes a phase adjustment component. The phase adjustment component includes a feed strip line and a plurality of phase adjustment strip lines of different lengths. The feed strip line is configured to transmit the electromagnetic signal to the radiation patch through the coupling structure. The feed strip line can be electrically connected to any phase adjustment strip line, to change a reflection phase of the electromagnetic signal.

### CROSS-REFERENCE TO RELATED APPLICATIONS

This application is a continuation of International Application No. PCT/CN2023/110166, filed on Jul. 31, 2023, which claims priority to Chinese Patent Application No. 202210922401.7, filed on Aug. 2, 2022. The disclosures of the aforementioned applications are hereby incorporated by reference in their entireties.

### TECHNICAL FIELD

This application relates to the field of communication technologies, and in particular, to an electromagnetic reflection apparatus and a base station.

### BACKGROUND

In network communication, one of technical means to improve coverage in indoor scenarios is to use an intelligent reflecting surface (IRS). The intelligent reflecting surface is usually used to control a propagation path of an electromagnetic wave in a passive manner, and reflect an electromagnetic signal of a point in strong coverage to a weak coverage area or a blind coverage area. Propagation paths of an electromagnetic wave are enriched to increase reference signal received power and a rank of a channel matrix on a receiving side, so that performance of coverage and a capacity in networking can be improved with low costs and low power consumption.

Currently, for the intelligent reflecting surface, a reflection phase of an electromagnetic wave is usually adjusted by adjusting an overall size of a radiation patch. However, when the overall size of the radiation patch changes, a resonance state of the radiation patch also changes accordingly, and different resonance states correspond to different reflection phase curve slopes of the electromagnetic wave. In this case, parallelism between different reflection phase curves changes greatly. Consequently, the intelligent reflecting surface has a reliable phase adjustment capability only at a center frequency in an operating bandwidth. When a frequency of an electromagnetic signal slightly shifts, a phase difference between adjacent reflection phase curves no longer meets a 90-degree difference relationship, and the phase adjustment capability degrades sharply. As a result, the reliable phase adjustment capability cannot be provided in a wide operating bandwidth. In other words, the reflection phase of the electromagnetic wave can be adjusted only in a narrow operating bandwidth.

### SUMMARY

This application provides an electromagnetic reflection apparatus and a base station, to adjust a reflection phase of an electromagnetic wave in a wide operating bandwidth.

According to a first aspect, this application provides an electromagnetic reflection apparatus, including a radiation portion and a phase adjustment portion that are disposed in a stacked manner. The radiation portion may include a radiation patch, and the radiation patch may receive and transmit an electromagnetic signal. The phase adjustment portion may include a coupling structure and a phase adjustment structure. The coupling structure may be located between the radiation patch and the phase adjustment structure, and the coupling structure may transmit the electromagnetic signal between the radiation patch and the phase adjustment structure. The phase adjustment structure may include a phase adjustment component, and the phase adjustment component may include a feed strip line and a plurality of phase adjustment strip lines of different lengths. The feed strip line may transmit the electromagnetic signal to the radiation patch through the coupling structure, and the feed strip line can be electrically connected to any phase adjustment strip line, to change a reflection phase of the electromagnetic signal.

According to the technical solution provided in this application, the phase adjustment portion is disposed to adjust a reflection phase of an electromagnetic wave in a manner of matching phase adjustment strip lines of different lengths. The reflection phase of the electromagnetic wave is changed without changing a reflection phase curve slope of the electromagnetic wave. After the reflection phase of the electromagnetic wave is adjusted to a specific phase, a reflection phase curve may be integrally shifted in the operating bandwidth; and parallelism between reflection phase curves corresponding to different reflection phases slightly changes, and a reliable phase adjustment capability may be provided at any frequency in the operating bandwidth. In this way, the reflection phase of the electromagnetic wave is adjusted in the wide operating bandwidth. In addition, the lengths of the phase adjustment strip lines are in one-to-one correspondence with reflection phases of the electromagnetic wave, so that the reflection phase of the electromagnetic wave can be adjusted with high precision in the operating bandwidth. Moreover, because the parallelism between the different reflection phase curves slightly changes, directions of beams reflected by the electromagnetic reflection apparatus may be consistent in the operating bandwidth, so that problems of an energy reduction and an interference increase of a wanted signal are effectively avoided.

In a specific implementable solution, the coupling structure may include a coupling patch, the coupling patch may be provided with a first slot and a second slot that are provided at an interval, the first slot may be provided in a first direction, the second slot may be provided in a second direction, and the first direction is perpendicular to the second direction. The first slot and the second slot may be provided to transmit a dual-polarized electromagnetic wave between the radiation patch and the phase adjustment structure. Two polarization directions in the dual-polarized electromagnetic wave may be isolated from each other during transmission, so that transmission in each polarization direction is independently performed. In this way, a reflection phase in each polarization direction is independently adjusted.

When the first slot is specifically provided, the first slot may be of a linear structure. The structure of the first slot is simple.

When the second slot is specifically provided, the second slot may include a first segment, a second segment, and a middle segment, the first segment and the second segment may be disposed in the first direction, the middle segment may be disposed in the second direction, and the first segment and the second segment are connected by using the middle segment. A structure of the second slot is simple.

In a specific implementable solution, there may be two phase adjustment components, and the two phase adjustment components may be disposed at an interval. The two phase adjustment components are respectively a first phase adjustment component and a second phase adjustment component. A feed strip line of the first phase adjustment component may be disposed in an overlapping manner with the first slot in a third direction, a feed strip line of the second phase adjustment component may be disposed in an overlapping manner with the second slot in the third direction, and the third direction is perpendicular to the first direction and the second direction. Therefore, the feed strip lines of the two phase adjustment components may separately and mutually couple energy with the coupling structure.

In a specific implementable solution, each phase adjustment strip line of the first phase adjustment component may be disposed in a staggered manner with the first slot in the third direction, and each phase adjustment strip line of the second phase adjustment component may be disposed in a staggered manner with the second slot in the third direction. Therefore, on the basis that the two phase adjustment components may separately and mutually couple energy with the coupling structure, the two phase adjustment components may implement independent control on reflection phase adjustment in each polarization direction in the dual-polarized electromagnetic wave.

When the phase adjustment strip line is specifically disposed, a shape of the phase adjustment strip line may be but is not limited to a straight-line shape, a fold-line shape, or a curve shape. A structure of the phase adjustment strip line is simple.

In a specific implementable solution, the radiation portion may further include a first circuit board. The first circuit board has a first surface and a second surface that are opposite to each other. The radiation patch may be disposed on the first surface of the first circuit board, and the second surface of the first circuit board may face the phase adjustment portion. It is convenient to dispose the radiation patch.

In a specific implementable solution, the coupling structure may be disposed on the second surface of the first circuit board. It is convenient to dispose the coupling structure.

In a specific implementable solution, the phase adjustment portion may further include a second circuit board. The second circuit board has a third surface and a fourth surface that are opposite to each other. The third surface of the second circuit board may face the radiation portion. In addition to the foregoing manner of disposing the coupling structure, another manner may be used. For example, the coupling structure may be disposed on the third surface of the second circuit board. The phase adjustment structure may be disposed on the fourth surface of the second circuit board. It is convenient to dispose both the coupling structure and the phase adjustment structure.

In a specific implementable solution, the electromagnetic reflection apparatus may further include a reflection portion, and the reflection portion and the radiation portion may be respectively located on two sides of the phase adjustment portion. The reflection portion may be disposed to reflect energy transmitted to the rear of the second circuit board back to the front, for example, may reflect energy leaked from the coupling structure to the rear of the second circuit board back to the front, and specifically, may reflect energy leaked from the first slot and the second slot to the rear of the second circuit board back to the front, to avoid an energy loss.

In a specific implementable solution, the reflection portion may include a reflection panel, and the reflection panel and the phase adjustment structure are disposed at an interval. The reflection panel can reflect energy and has a simple structure.

According to a second aspect, this application provides a base station, including an antenna and the electromagnetic reflection apparatus according to any one of the implementable solutions of the first aspect. The antenna is configured to receive and transmit an electromagnetic signal, and the electromagnetic reflection apparatus is configured to receive and reflect the electromagnetic signal transmitted by the antenna.

According to the technical solution provided in this application, the electromagnetic reflection apparatus may adjust a reflection phase of an electromagnetic wave in a wide operating bandwidth, and adjustment precision is high. An electromagnetic signal transmitted by an antenna of a base station may be reflected from a point in strong coverage to a weak coverage area or a blind coverage area, for example, an indoor area, and coverage performance of the base station is ideal.

### BRIEF DESCRIPTION OF DRAWINGS

FIG. 1 is a diagram of an application scenario of an intelligent reflecting surface in the conventional technology;

FIG. 2 is a diagram of another application scenario of an intelligent reflecting surface in the conventional technology;

FIG. 3 is a diagram of a structure of an electromagnetic reflection apparatus according to an embodiment of this application;

FIG. 4 is a diagram of a structure of a radiation portion of an electromagnetic reflection apparatus according to an embodiment of this application;

FIG. 5 is a diagram of a structure of one surface of a phase adjustment portion of an electromagnetic reflection apparatus according to an embodiment of this application;

FIG. 6 is a diagram of a structure of another surface of a phase adjustment portion of an electromagnetic reflection apparatus according to an embodiment of this application;

FIG. 7 is a diagram of a structure of a coupling structure of an electromagnetic reflection apparatus according to an embodiment of this application; and

FIG. 8 is a diagram of a structure of a phase adjustment portion of an electromagnetic reflection apparatus according to an embodiment of this application.

### REFERENCE NUMERALS

1—Intelligent reflecting surface; 2—Base station; 100—Radiation portion; 200—Phase adjustment portion; 300—Reflection portion; 110—First circuit board;
120—Radiation patch; 210—Second circuit board; 220—Coupling structure; 230—Phase adjustment structure; 221—First slot;
222—Second slot; 231—Feed strip line; 232—Phase adjustment strip line; 233—Switch; 234—First phase adjustment component;
235—Second phase adjustment component; 2221—First segment; 2222—Second segment; and 2223—Middle segment.

### DETAILED DESCRIPTION OF ILLUSTRATIVE EMBODIMENTS

The following describes in detail embodiments of this application with reference to the accompanying drawings.

For ease of understanding, an application scenario of an electromagnetic reflection apparatus in this application is first described. The electromagnetic reflection apparatus provided in embodiments of this application may be used in a communication system architecture of an intelligent reflecting surface. During actual use, the electromagnetic reflection apparatus may adapt to a base station (BS), and may be used as an intelligent reflecting surface (IRS) that is configured to receive an electromagnetic signal transmitted by an antenna of the base station and reflect the electromagnetic signal.

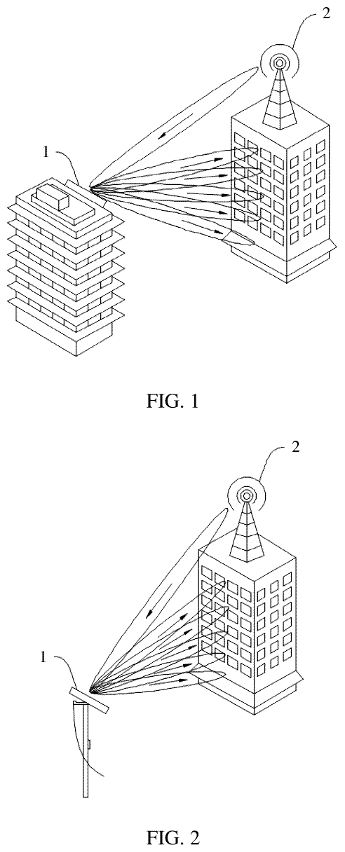

The intelligent reflecting surface is mainly used to improve indoor coverage performance of an electromagnetic signal in densely populated urban areas. During specific application, as shown in FIG. 1, an intelligent reflecting surface 1 may be deployed on an outer wall of a building, or as shown in FIG. 2, the intelligent reflecting surface 1 may be deployed on a mounting pole. The intelligent reflecting surface 1 may reflect an electromagnetic signal transmitted by an antenna of a base station 2 from a point in strong coverage to a weak coverage area or a blind coverage area, for example, an indoor area, to improve coverage performance of the electromagnetic signal in the area. Currently, for the intelligent reflecting surface, a reflection phase of an electromagnetic wave is usually adjusted by adjusting an overall size of a radiation patch. However, when the overall size of the radiation patch changes, a resonance state of the radiation patch also changes accordingly, and different resonance states correspond to different reflection phase curve slopes of the electromagnetic wave. In this case, parallelism between different reflection phase curves changes greatly. Consequently, the intelligent reflecting surface has a reliable phase adjustment capability only at a center frequency in an operating bandwidth. When a frequency of an electromagnetic signal slightly shifts, the phase adjustment capability degrades sharply. As a result, the reflection phase of the electromagnetic wave can be adjusted only in a narrow operating bandwidth.

Based on this, embodiments of this application provide an electromagnetic reflection apparatus, to adjust a reflection phase of an electromagnetic wave in a wide operating bandwidth.

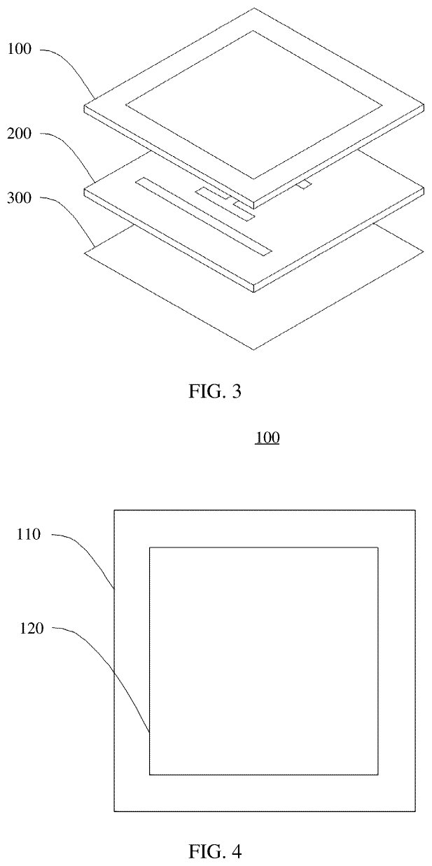

First refer to FIG. 3. FIG. 3 is a diagram of a structure of the electromagnetic reflection apparatus according to an embodiment of this application. As shown in FIG. 3, the electromagnetic reflection apparatus provided in this embodiment of this application may include a radiation portion 100, a phase adjustment portion 200, and a reflection portion 300 that are disposed in a stacked manner.

FIG. 4 is a diagram of a structure of the radiation portion of the electromagnetic reflection apparatus according to an embodiment of this application. With reference to FIG. 3 and FIG. 4, the radiation portion 100 may include a first circuit board 110 and a radiation patch 120. The first circuit board 110 has a first surface and a second surface that are opposite to each other. The radiation patch 120 may be disposed on the first surface of the first circuit board 110, and the second surface of the first circuit board 110 faces the phase adjustment portion 200. The radiation patch 120 may receive and transmit an electromagnetic signal, and the radiation patch 120 may be made of a metal material.

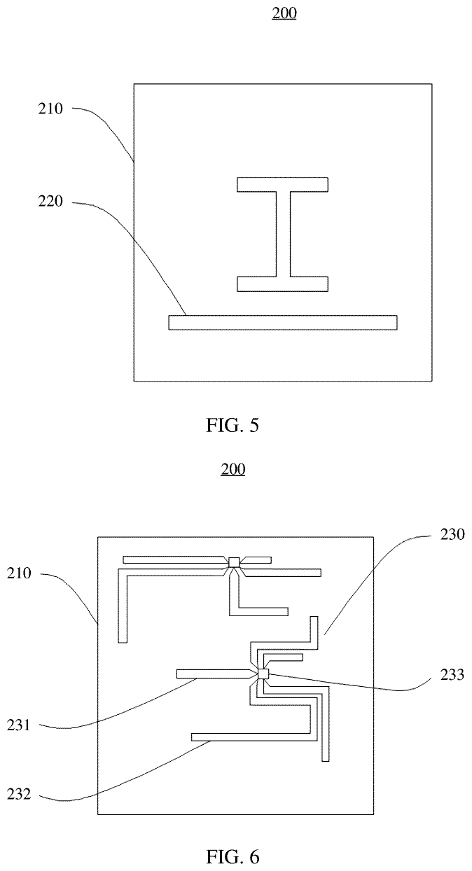

Refer to FIG. 5 and FIG. 6 together. FIG. 5 is a diagram of a structure of one surface of the phase adjustment portion of the electromagnetic reflection apparatus according to an embodiment of this application, and FIG. 6 is a diagram of a structure of another surface of the phase adjustment portion of the electromagnetic reflection apparatus according to an embodiment of this application. With reference to FIG. 4, FIG. 5, and FIG. 6, the phase adjustment portion 200 may include a second circuit board 210, a coupling structure 220, and a phase adjustment structure 230, and the second circuit board 210 may be disposed in parallel with the first circuit board 110. The coupling structure 220 may be located between the radiation patch 120 and the phase adjustment structure 230. Specifically, the second circuit board 210 has a third surface and a fourth surface that are opposite to each other, and the third surface of the second circuit board 210 faces the radiation portion 100. The coupling structure 220 may be disposed on the third surface of the second circuit board 210, or the coupling structure 220 may be disposed on the second surface of the first circuit board 110. The phase adjustment structure 230 may be disposed on the fourth surface of the second circuit board 210. The second circuit board 210 may abut against the first circuit board 110, that is, the third surface of the second circuit board 210 may abut against the second surface of the first circuit board 110. In this case, the coupling structure 220 may be disposed between the second circuit board 210 and the first circuit board 110. Alternatively, a dielectric layer may be further disposed between the second circuit board 210 and the first circuit board 110, that is, a dielectric layer may be disposed between the third surface of the second circuit board 210 and the second surface of the first circuit board 110. The second circuit board 210 may be fastened to the first circuit board 110 through the dielectric layer. In this case, the coupling structure 220 may be disposed on the third surface of the second circuit board 210 or the second surface of the first circuit board 110.

During specific application, the coupling structure 220 may transmit the electromagnetic signal between the radiation patch 120 and the phase adjustment structure 230. Specifically, the coupling structure 220 may couple the electromagnetic wave received by the radiation patch 120 from free space to the phase adjustment structure 230, and couple the electromagnetic wave on the phase adjustment structure 230 to the radiation patch 120 and then transmit the electromagnetic wave to the free space. The radiation patch 120 and the phase adjustment structure 230 are separated from each other, and the radiation patch 120 and the phase adjustment structure 230 are isolated through the coupling structure 220, so that the radiation patch 120 and the phase adjustment structure 230 may be independent of each other in terms of a structural design, and may not affect each other in terms of performance. For example, the phase adjustment structure 230 does not affect a resonance state of the radiation patch 120.

In a specific implementation, the phase adjustment structure 230 may include a phase adjustment component, and the phase adjustment component may include a feed strip line 231 and a plurality of phase adjustment strip lines 232 of different lengths. The feed strip line 231 may transmit the electromagnetic signal to the radiation patch 120 through the coupling structure 220. Specifically, the electromagnetic wave received by the radiation patch 120 may be coupled to the feed strip line 231 through the coupling structure 220, and the electromagnetic wave on the feed strip line 231 may be coupled to the radiation patch 120 through the coupling structure 220. The feed strip line 231 can be electrically connected to any phase adjustment strip line 232. For example, the feed strip line 231 may be electrically connected to the phase adjustment strip line 232 through a switch 233. Specifically, the switch 233 may be a single-pole multi-throw switch, to reduce control complexity and power consumption.

During actual application, the base station may send an instruction to control the switch 233, so that the feed strip line 231 is electrically connected to a phase adjustment strip line 232 of a specific length. In this way, an electromagnetic wave coupled to the feed strip line 231 may be adjusted to a specific phase, and the electromagnetic wave adjusted to the phase is returned to the feed strip line 231, and is coupled to the radiation patch 120 through the coupling structure 220 and then transmitted to the free space. In this way, the electromagnetic wave can be reflected, and a reflection phase of the electromagnetic wave can be adjusted. There may be a plurality of phase adjustment strip lines 232, and lengths of the phase adjustment strip lines may be different, so that diversified reflection phase adjustment of the electromagnetic wave can be implemented.

According to the electromagnetic reflection apparatus in embodiments of this application, a size of the radiation patch 120 is not changed, so that a resonance state of the radiation patch 120 may remain unchanged. In addition, the phase adjustment portion 200 is disposed to adjust the reflection phase of the electromagnetic wave in a manner of matching phase adjustment strip lines 232 of different lengths. The reflection phase of the electromagnetic wave is changed without changing a reflection phase curve slope of the electromagnetic wave. After the reflection phase of the electromagnetic wave is adjusted to a specific phase, a reflection phase curve may be integrally shifted in the operating bandwidth; and parallelism between reflection phase curves corresponding to the different reflection phases slightly changes, and a reliable phase adjustment capability may be provided at any frequency in the operating bandwidth. In this way, the reflection phase of the electromagnetic wave is adjusted in the wide operating bandwidth. Moreover, because the parallelism between the different reflection phase curves slightly changes, directions of beams reflected by the electromagnetic reflection apparatus may be consistent in the operating bandwidth, so that problems of an energy reduction and an interference increase of a wanted signal are effectively avoided.

In a specific implementation, for example, there may be four phase adjustment strip lines 232. A phase delay of the electromagnetic wave is changed by using four phase adjustment strip lines 232 of different lengths, so that 2-bit (where there are four phases, and a difference between adjacent phases may be 90 degrees) reflection phase adjustment may be performed on the electromagnetic wave. In addition, the lengths of the phase adjustment strip lines 232 are in one-to-one correspondence with reflection phases of the electromagnetic wave, so that the reflection phase of the electromagnetic wave can be accurately changed. Therefore, the electromagnetic reflection apparatus in embodiments of this application may adjust the reflection phase of the electromagnetic wave with high precision in the operating bandwidth.

In a specific implementation, with reference to FIG. 3 together, the reflection portion 300 and the radiation portion 100 may be respectively located on two sides of the phase adjustment portion 200. The reflection portion 300 may include a reflection panel, and the reflection panel may be made of a metal material. During actual application, the reflection panel may reflect energy leaked from the coupling structure 220 to the rear of the second circuit board 210 back to the front, to avoid an energy loss. Therefore, in the electromagnetic reflection apparatus in embodiments of this application, after receiving the electromagnetic wave from the free space, there are two energy transmission paths for the electromagnetic wave. One path is “the radiation patch 120—the coupling structure 220—the feed strip line 231 of the phase adjustment structure 230—the phase adjustment strip line 232 of the phase adjustment structure 230—the feed strip line 231 of the phase adjustment structure 230—the coupling structure 220—the radiation patch 120”. The other path is “the radiation patch 120—the coupling structure 220—the reflection panel—the coupling structure 220—the radiation patch 120”.

In a specific implementation, the reflection panel and the phase adjustment structure 230 may be disposed at an interval. In a possible implementation, the reflection panel may be disposed on the fourth surface of the second circuit board 210, a dielectric layer may be further disposed between the reflection panel and the phase adjustment structure 230, and the reflection panel may be fastened to the fourth surface of the second circuit board 210 through the dielectric layer. In another possible implementation, the reflection portion 300 may further include a third circuit board, the third circuit board has a fifth surface and a sixth surface that are opposite to each other, the fifth surface of the third circuit board faces the phase adjustment portion 200, and the reflection panel may be disposed on the fifth surface or the sixth surface of the third circuit board. The third circuit board may be disposed in parallel with the second circuit board 210, so that the first circuit board 110, the second circuit board 210, and the third circuit board may be disposed in parallel. A dielectric layer may be disposed between the third circuit board and the second circuit board 210, that is, the dielectric layer may be disposed between the fifth surface of the third circuit board and the fourth surface of the second circuit board 210, and the third circuit board is fastened to the second circuit board 210 through the dielectric layer. When the reflection panel is disposed on the fifth surface of the third circuit board, the dielectric layer is located between the reflection panel and the phase adjustment structure 230.

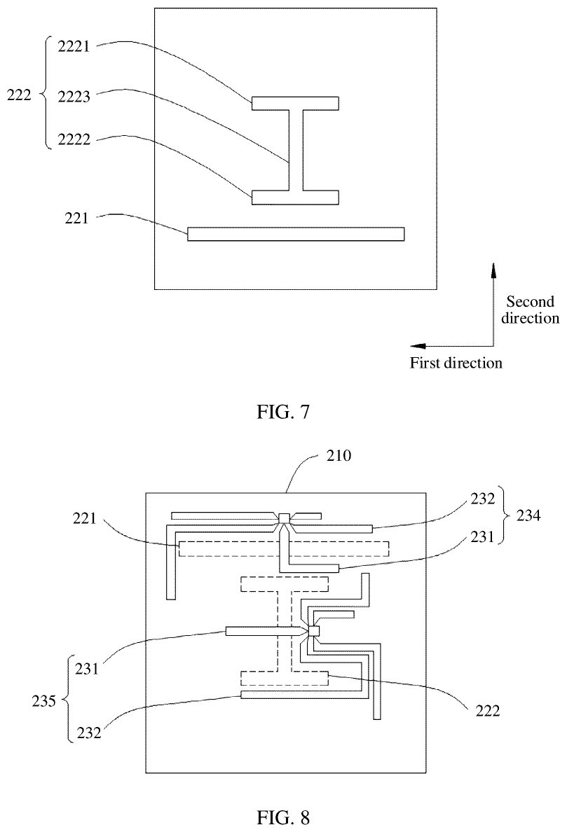

FIG. 7 is a diagram of a structure of the coupling structure of the electromagnetic reflection apparatus according to an embodiment of this application. With reference to FIG. 4, FIG. 5, and FIG. 7, in a possible embodiment, the coupling structure 220 may include a coupling patch, and the coupling patch may be made of a metal material. A first slot 221 and a second slot 222 that run through the coupling patch and that are provided at an interval may be provided on the coupling patch. The first slot 221 may be provided in a first direction, and the second slot 222 may be provided in a second direction. The first direction is perpendicular to the second direction, that is, the first slot 221 is perpendicular to the second slot 222. When the radiation patch 120 receives and transmits a dual-polarized electromagnetic wave, the coupling structure 220 that has two slot structures, that is, the first slot 221 and the second slot 222 may transmit the dual-polarized electromagnetic wave between the radiation patch 120 and the phase adjustment structure 230. Two polarization directions in the dual-polarized electromagnetic wave may be isolated from each other during transmission, so that transmission in each polarization direction is independently performed. In this way, a reflection phase in each polarization direction may be independently adjusted.

In a specific implementation, the first slot 221 may be of a linear structure, and may be disposed in the first direction. In a possible implementation, the second slot 222 may include a first segment 2221, a second segment 2222, and a middle segment 2223, the first segment 2221 and the second segment 2222 may be disposed in the first direction, the middle segment 2223 may be disposed in the second direction, and the first segment 2221 and the second segment 2222 are connected by using the middle segment 2223, so that space occupied by the second slot in the second direction can be reduced. The second slot 222 may be of an I-shaped structure, or may be of an H-shaped structure. Specifically, one end of the middle segment 2223 may be connected to a middle position of the first segment 2221, and the other end of the middle segment 2223 may be connected to a middle position of the second segment 2222. In another possible implementation, the second slot 222 may also be of a linear structure, and may be disposed in the second direction. Similarly, the first slot 221 may also be of an I-shaped structure, and the middle segment of the first slot 221 may be disposed in the first direction.

In a specific implementation, for reference, a length of the slot structure (e.g., the first slot 221 or the second slot 222) may match a weak resonance state, so that energy leakage to the free space may be effectively reduced, and the energy may be effectively coupled from the radiation patch 120 to the phase adjustment structure 230. Specifically, the length of the slot structure may be greater than or less than ½λ, where λ is an equivalent wavelength of an electromagnetic wave that has been affected by a dielectric constant of a medium around the slot structure. When the slot structure is of the linear structure, the length of the slot structure is the length of the linear structure. When the slot structure is of the I-shaped structure, the length of the slot structure is a sum of a half of a length of the first segment, a half of a length of the second segment, and a length of the middle segment of the slot structure.

FIG. 8 is a diagram of a structure of the phase adjustment portion of the electromagnetic reflection apparatus according to an embodiment of this application. A dashed line in the figure represents the slot structure. As shown in FIG. 8, in a possible embodiment, there may be two phase adjustment components, the two phase adjustment components may be disposed at an interval, and the two phase adjustment components may be respectively disposed in correspondence with the first slot 221 and the second slot 222. For ease of description, the two phase adjustment components are respectively referred to as a first phase adjustment component 234 and a second phase adjustment component 235. A feed strip line 231 of the first phase adjustment component 234 may be disposed in an overlapping manner with the first slot 221 in a third direction, and a feed strip line 231 of the second phase adjustment component 235 may be disposed in an overlapping manner with the second slot 222 in the third direction. The third direction is perpendicular to the first direction and the second direction, that is, the third direction is perpendicular to the second circuit board 210. In the third direction, that is, in a direction perpendicular to the second circuit board 210, the feed strip line 231 is disposed in the overlapping manner with the first slot 221 (or the second slot 222). Therefore, the feed strip line 231 and the coupling structure 220 may couple energy to each other. In a specific implementation, in the third direction, the feed strip line 231 may be disposed in an overlapping manner with a middle position of the first slot 221, an electric field at the middle position of the first slot 221 is strong, and a coupling effect is ideal. Similarly, the feed strip line 231 may be disposed in an overlapping manner with a middle position of the middle segment of the second slot 222.

In a possible embodiment, the phase adjustment strip lines 232 of the first phase adjustment component 234 are separately disposed in a staggered manner with the first slot 221 and are also separately disposed in a staggered manner with the second slot 222 in the third direction. The phase adjustment strip lines 232 of the second phase adjustment component 235 are separately disposed in a staggered manner with the second slot 222 and are also separately disposed in a staggered manner with the first slot 221 in the third direction.

In a specific implementation, the feed strip line 231 of the first phase adjustment component 234 is disposed in an overlapping manner with the first slot 221 in the third direction. The electromagnetic wave may be transmitted between the feed strip line 231 of the first phase adjustment component 234 and the radiation patch 120. Specifically, transmission in one polarization direction in the dual-polarized electromagnetic wave may be performed. Each of the phase adjustment strip lines 232 of the first phase adjustment component 234 may be disposed in a staggered manner with the first slot 221 in the third direction. The feed strip line 231 of the first phase adjustment component 234 can be electrically connected to any phase adjustment strip line 232. Similarly, the feed strip line 231 of the second phase adjustment component 235 is disposed in an overlapping manner with the second slot 222 in the third direction. The electromagnetic wave may be transmitted between the feed strip line 231 of the second phase adjustment component 235 and the radiation patch 120. Specifically, transmission in the other polarization direction in the dual-polarized electromagnetic wave may be performed. Each of the phase adjustment strip lines 232 of the second phase adjustment component 235 may be disposed in a staggered manner with the second slot 222 in the third direction. The feed strip line 231 of the second phase adjustment component 235 can be electrically connected to any phase adjustment strip line 232. In this way, adjustment in a reflection phase in each polarization direction in the dual-polarized electromagnetic wave can be independently controlled.

In a possible embodiment, the phase adjustment strip lines 232 may be in straight-line shapes. In this case, the phase adjustment strip lines 232 may be disposed in parallel with the slot structure. When the lengths of the phase adjustment strip lines 232 are large, the phase adjustment strip lines 232 may also be in fold-line shapes or in curve shapes, so that space occupied by the phase adjustment strip lines 232 can be reduced. This facilitates product miniaturization.

The foregoing descriptions are merely specific implementations of this application, but are not intended to limit the protection scope of this application. Any variation or replacement readily figured out by a person skilled in the art within the technical scope disclosed in this application shall fall within the protection scope of this application.

1-20. (canceled)

21. An apparatus, comprising a radiation portion and a phase adjustment portion that are stacked, wherein:
the radiation portion comprises a radiation patch, and the radiation patch is configured to receive and transmit an electromagnetic signal; and
the phase adjustment portion comprises a coupling structure and a phase adjustment structure, the coupling structure is located between the radiation patch and the phase adjustment structure, and the coupling structure is configured to transmit the electromagnetic signal between the radiation patch and the phase adjustment structure,
wherein the phase adjustment structure comprises a phase adjustment component, and the phase adjustment component comprises a feed strip line and a plurality of phase adjustment strip lines of different lengths,
wherein the feed strip line is configured to transmit the electromagnetic signal to the radiation patch through the coupling structure, and the feed strip line is configured to be electrically connected to any one of the phase adjustment strip lines to change a reflection phase of the electromagnetic signal.

22. The apparatus according to claim 21, wherein the coupling structure comprises a coupling patch, the coupling patch comprises a first slot and a second slot that are provided at an interval, the first slot is longer in a first direction, the second slot is longer in a second direction, and the first direction is perpendicular to the second direction.

23. The apparatus according to claim 22, wherein the first slot is a linear structure.

24. The apparatus according to claim 22, wherein the second slot comprises a first segment, a second segment, and a middle segment, the first segment and the second segment are disposed in the first direction, the middle segment is disposed in the second direction, and the first segment and the second segment are connected by using the middle segment.

25. The apparatus according to claim 22, wherein the phase adjustment structure comprises two phase adjustment components, and the two phase adjustment components are disposed at an interval; and
the two phase adjustment components comprise a first phase adjustment component and a second phase adjustment component, a feed strip line of the first phase adjustment component is disposed overlapping with the first slot in a third direction, a feed strip line of the second phase adjustment component is disposed overlapping with the second slot in the third direction, and the third direction is perpendicular to the first direction and the second direction.

26. The apparatus according to claim 25, wherein each phase adjustment strip line of the first phase adjustment component is disposed staggered with the first slot in the third direction, and each phase adjustment strip line of the second phase adjustment component is disposed staggered with the second slot in the third direction.

27. The apparatus according to claim 21, wherein each phase adjustment strip line of the phase adjustment strip lines comprises a straight-line shape, a fold-line shape, or a curve shape.

28. The apparatus according to claim 21, wherein the radiation portion further comprises a first circuit board, the first circuit board comprises a first surface and a second surface that are opposite to each other, the radiation patch is disposed on the first surface of the first circuit board, and the second surface of the first circuit board faces the phase adjustment portion.

29. The apparatus according to claim 28, wherein the coupling structure is disposed on the second surface of the first circuit board.

30. The apparatus according to claim 21, wherein the phase adjustment portion further comprises a second circuit board, the second circuit board comprises a third surface and a fourth surface that are opposite to each other, the third surface of the second circuit board faces the radiation portion, the coupling structure is disposed on the third surface of the second circuit board, and the phase adjustment structure is disposed on the fourth surface of the second circuit board.

31. The apparatus according to claim 21, further comprising a reflection portion, wherein the reflection portion and the radiation portion are located on different sides of the phase adjustment portion respectively.

32. The apparatus according to claim 31, wherein the reflection portion comprises a reflection panel, and the reflection panel and the phase adjustment structure are disposed at an interval.

33. A base station, comprising an antenna and an electromagnetic reflection apparatus, wherein the electromagnetic reflection apparatus comprises a radiation portion and a phase adjustment portion that are stacked, wherein:
the radiation portion comprises a radiation patch, and the radiation patch is configured to receive and transmit an electromagnetic signal; and
the phase adjustment portion comprises a coupling structure and a phase adjustment structure, the coupling structure is located between the radiation patch and the phase adjustment structure, and the coupling structure is configured to transmit the electromagnetic signal between the radiation patch and the phase adjustment structure,
wherein the phase adjustment structure comprises a phase adjustment component, and the phase adjustment component comprises a feed strip line and a plurality of phase adjustment strip lines of different lengths,
wherein the feed strip line is configured to transmit the electromagnetic signal to the radiation patch through the coupling structure, and the feed strip line is configured to be electrically connected to any one of the phase adjustment strip lines to change a reflection phase of the electromagnetic signal.

34. The base station according to claim 33, wherein the coupling structure comprises a coupling patch, the coupling patch comprises a first slot and a second slot that are provided at an interval, the first slot is longer in a first direction, the second slot is longer in a second direction, and the first direction is perpendicular to the second direction.

35. The base station according to claim 34, wherein the first slot is a linear structure.

36. The base station according to claim 34, wherein the second slot comprises a first segment, a second segment, and a middle segment, the first segment and the second segment are disposed in the first direction, the middle segment is disposed in the second direction, and the first segment and the second segment are connected by using the middle segment.

37. The base station according to claim 34, wherein the phase adjustment structure comprises two phase adjustment components, and the two phase adjustment components are disposed at an interval; and
the two phase adjustment components comprise a first phase adjustment component and a second phase adjustment component, a feed strip line of the first phase adjustment component is disposed overlapping with the first slot in a third direction, a feed strip line of the second phase adjustment component is disposed overlapping with the second slot in the third direction, and the third direction is perpendicular to the first direction and the second direction.

38. The base station according to claim 37, wherein each phase adjustment strip line of the first phase adjustment component is disposed staggered with the first slot in the third direction, and each phase adjustment strip line of the second phase adjustment component is disposed staggered with the second slot in the third direction.

39. The base station according to claim 37, wherein each phase adjustment strip line of the phase adjustment strip lines comprises a straight-line shape, a fold-line shape, or a curve shape.

40. The base station according to claim 33, wherein the radiation portion further comprises a first circuit board, the first circuit board comprises a first surface and a second surface that are opposite to each other, the radiation patch is disposed on the first surface of the first circuit board, and the second surface of the first circuit board faces the phase adjustment portion.
